(19) United States
(12) Patent Application Publication
(10) Pub. No.: US 2025/0389040 A1
(43) Pub. Date: Dec. 25, 2025

(54) CATION REDUCTION DEVICE AND HYDROGEN GAS GENERATION SYSTEM

(71) Applicant: Sharp Kabushiki Kaisha, Sakai City (JP)

(72) Inventors: Takafumi NONAKA, Sakai City (JP); Hidetsugu Kawai, Sakai City (JP)

(21) Appl. No.: 19/236,001

(22) Filed: Jun. 12, 2025

(30) Foreign Application Priority Data
Jun. 20, 2024 (JP) 2024-099706

(51) Int. Cl. C25B 15/08; B01J 19/12; B01J 23/30; B01J 35/39; C25B 9/19

(52) U.S. Cl. CPC C25B 15/081; B01J 19/122; B01J 23/30; B01J 35/39; C25B 9/19; C25B 15/087; B01J 2219/00045; B01J 2219/0869; B01J 2219/0877; B01J 2219/0892

(57) ABSTRACT

A cation reduction device according to the disclosure includes a photocatalytic cell containing an electrolyte containing a first cation and photocatalyst particles, in which the electrolyte and the photocatalyst particles reduce the first cation to a second cation by photocatalytic activity of the photocatalyst particles generated by receiving light, and a pH of the electrolyte is within a pH range in which a zeta potential of the photocatalyst particles is 0 mV or higher.

### INCORPORATION BY REFERENCE

This application claims priority under Section 119 of U.S.C. to Japanese Patent Application No. 2024-099706 filed on Jun. 20, 2024, the entire content of which is incorporated herein by reference.

### TECHNICAL FIELD

The disclosure relates to a cation reduction device and a hydrogen gas generation system.

### BACKGROUND ART

Since no CO₂ is emitted when hydrogen gas is used, hydrogen gas is expected to be a next generation energy source. In particular, “green hydrogen”, which is produced by electrolyzing water using electricity generated by solar or wind power, is attracting attention because no CO₂ is emitted during a production process of hydrogen. However, green hydrogen has a problem of high production cost. An electrolysis voltage of industrially used water electrolyzers is 1.5 to 2.1 V, which consumes a lot of power. A known device capable of generating hydrogen gas from water at a low electrolysis voltage is one that combines a photocatalyst that reduces cations with an electrolytic cell that generates hydrogen gas (see, for example, JP 11-157801 A).

### SUMMARY

The disclosure provides a cation reduction device including a photocatalytic cell containing an electrolyte containing a first cation and photocatalyst particles, in which the electrolyte and the photocatalyst particles reduce the first cation to a second cation by photocatalytic activity of the photocatalyst particles generated by receiving light, and a pH of the electrolyte is within a pH range in which a zeta potential of the photocatalyst particles is 0 mV or higher.

### ADVANTAGEOUS EFFECTS OF DISCLOSURE

The pH of the electrolyte contained in the cation reduction device according to the disclosure is within the pH range in which the zeta potential of the photocatalyst particles is 0 mV or higher. Thus, a probability of a cation coming into contact with the photocatalyst particle can be increased by electrostatic attraction force, thereby increasing an efficiency of reducing the first cation to the second cation.

### BRIEF DESCRIPTION OF THE DRAWINGS

FIG. 1 is a schematic cross-sectional view of a cation reduction device according to an embodiment of the disclosure.

FIG. 2 is a schematic cross-sectional view of a hydrogen gas generation system according to an embodiment of the disclosure.

FIG. 3 is a graph showing results of zeta potential measurement.

### DETAILED DESCRIPTION OF THE INVENTION

A cation reduction device according to the disclosure includes a photocatalytic cell containing an electrolyte containing a first cation and photocatalyst particles, in which the electrolyte and the photocatalyst particles reduce the first cation to a second cation by photocatalytic activity of the photocatalyst particles generated by receiving light, and a pH of the electrolyte is within a pH range in which a zeta potential of the photocatalyst particles is 0 mV or higher.

The pH of the electrolyte is preferably less than 2.

The first cation is preferably a trivalent iron ion and the second cation is preferably a divalent iron ion.

The electrolyte preferably contains iron ions at a concentration of 10 mmol/L or more and 1 mol/L or less.

The photocatalytic cell preferably includes an inlet provided for supplying an electrolyte containing a first cation into the photocatalytic cell, and an outlet provided for discharging an electrolyte containing a second cation from the photocatalytic cell.

The photocatalyst particles preferably include tungsten oxide particles.

The photocatalyst particles are preferably supported or fixed on a support.

The disclosure also provides a hydrogen gas generation system including the cation reduction device according to the disclosure and an electrolyzer including a cathode and an anode, in which the electrolyzer generates hydrogen gas from water or hydrogen ions at the cathode and oxidizes a second cation to a first cation at the anode, and the cation reduction device and the electrolyzer supply an electrolyte containing the second cation generated by the cation reduction device to the electrolyzer and supply an electrolyte containing the first cation generated at the anode to the cation reduction device.

An embodiment of the disclosure will be described below with reference to the drawings. Configurations illustrated in the drawings and the following description are examples, and the scope of the disclosure is not limited to the configurations illustrated in the drawings or the following description.

### Cation Reduction Device

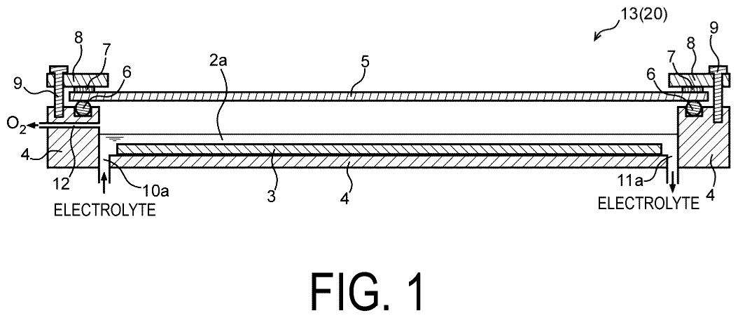

FIG. 1 is a schematic cross-sectional view of a cation reduction device according to the present embodiment.

A cation reduction device 20 according to the present embodiment includes a photocatalytic cell 13 containing an electrolyte 2a containing a first cation and photocatalyst particles. The electrolyte and the photocatalyst particles are provided so that the first cation is reduced to a second cation by photocatalytic activity of the photocatalyst particles generated by receiving light, and a pH of the electrolyte is within a pH range in which a zeta potential of the photocatalyst particles is 0 mV or higher.

The cation reduction device is a device that reduces a first cation contained in the electrolyte 2a to a second cation by photocatalytic activity. This device can produce an electrolyte containing the second cation.

The photocatalytic cell 13 is a cell that contains the electrolyte 2a and the photocatalyst particles. The photocatalytic cell 13 may include a translucent member 5. This allows light transmitted through the translucent member 5 to be irradiated onto the photocatalyst particles, allowing the photocatalyst particles to have photocatalytic activity.

The photocatalytic cell 13 includes, for example, a container 4 and the translucent member 5 that covers an opening of the container 4, as illustrated in FIG. 1. The translucent member 5 is fixed to the container 4 by a cover 8 and bolts 9. A cushioning material 7 is provided between the translucent member 5 and the cover 8, and a sealing member 6 is provided between the container 4 and the translucent member 5.

The photocatalytic cell 13 may have a flat shape, and the translucent member 5 that serves as a light-receiving surface may be placed on a wide surface having the flat shape.

The photocatalyst particles are not limited as long as the photocatalyst particles are particles that generate photocatalytic activity by receiving light. For example, the photocatalyst particles may include tungsten oxide particles, titanium oxide particles, or the like, and preferably include tungsten oxide particles (WO₃ particles).

Tungsten oxide has a wider light absorption band than titanium dioxide and reacts even with visible light that does not contain ultraviolet light. Therefore, photocatalytic activity can be caused even when light incident on the photocatalytic cell 13 passes through the electrolyte 2a and is then irradiated onto tungsten oxide particles (photocatalyst particles).

The tungsten oxide particles (WO₃ particles) included in the photocatalyst particles may be tungsten oxide particles having a composition deviating from a stoichiometric composition as long as the tungsten oxide particles have photocatalytic activity. The tungsten oxide particles may contain impurity atoms or additive atoms within a range in which photocatalytic activity is not lost. The photocatalyst particle may have a promoter on a surface thereof. Examples of promoters include platinum group metals such as Pt, Pd, Rh, Ru, Os, and Ir.

The photocatalyst particles may be contained in the photocatalytic cell 13 in powder form, may be contained in the photocatalytic cell 13 as a compact of photocatalyst powder, or may be contained in the photocatalytic cell 13 as a photocatalyst support 3 in which the photocatalyst particles are supported or fixed on a support. In FIG. 1, the photocatalyst support 3 containing photocatalyst particles is contained in the photocatalytic cell 13. In the photocatalyst support 3, the photocatalyst particles may be supported or fixed on paper, may be supported or fixed on a filter, may be supported or fixed on a porous body, or may be supported or fixed on a translucent member such as a glass substrate.

In the photocatalytic cell 13, surfaces of the photocatalyst particles are in contact with the electrolyte 2a. When the photocatalyst particle receives light, the first cation in the electrolyte 2a is reduced to the second cation, and oxygen gas is generated from the electrolyte 2a. This can be explained as follows. Light excites an electron in a valence band of the photocatalyst particle to a conduction band, forming a hole in the valence band. The electron in the conduction band moves to a surface of the photocatalyst particle, and the first cation to which the electron is added is reduced to the second cation (first reaction). Further, the hole in the valence band moves to the surface of the photocatalyst particle and react with H₂O to generate oxygen gas (second reaction). The generated oxygen gas moves into a gas phase in the photocatalytic cell 13 and is discharged to the outside of the photocatalytic cell 13 through an oxygen gas discharge hole 12.

For example, when the first cation is a trivalent iron ion (Fe³⁺) and the second cation is a divalent iron ion (Fe²⁺), the following reactions proceed.

First reaction: Fe³⁺+e⁻→Fe²⁺

Second reaction: 2H₂O→O₂+4H⁺+4e⁻

The generated hydrogen ions (H⁺) can be used in an electrolyzer 30 described later.

In the photocatalytic cell 13, the photocatalyst particles or the photocatalyst support 3 may be immersed in the electrolyte 2a. In the photocatalytic cell 13, the powdered photocatalyst particles, the photocatalyst particles formed into the compact, or the photocatalyst support 3 may be permeated with the electrolyte 2a.

The powdered photocatalyst particles, the photocatalyst particles formed into the compact, or the photocatalyst support 3 may be placed at a bottom of the container 4.

The electrolyte 2a is an aqueous solution containing a first cation. The first cation is reduced to a second cation by photocatalytic activity of the photocatalyst particle generated by receiving light.

When the electrolyte 2a contains iron sulfates (FeSO₄ and Fe₂(SO₄)₃), the first cation is a trivalent iron ion and the second cation is a divalent iron ion.

When the electrolyte 2a contains iron perchlorates (Fe(ClO₄)₃ and Fe(ClO₄)₂), the first cation is a trivalent iron ion and the second cation is a divalent iron ion.

The first and second cations may be metal complex ions. Metal contained in the metal complex ion is, for example, iron or cobalt.

A pH of the electrolyte 2a is within a pH range in which a zeta potential of the photocatalyst particles is 0 mV or higher. Electrostatic attraction force generated by this can increase a probability of contact between the photocatalyst particle and the first cation, thereby increasing a probability of reduction of the first cation to the second cation by photocatalytic activity. Thus, an electrolyte containing a larger amount of second cations can be produced. Further, by using this electrolyte to generate hydrogen gas in a hydrogen gas generation system described later, an efficiency of generating hydrogen gas can be improved.

When the photocatalyst particles include the tungsten oxide particles, a pH of the electrolyte 2a can be made smaller than 2 (to be on an acidic side). This allows the zeta potential of the photocatalyst particles to be made 0 mV or higher, and also allows divalent iron ions and trivalent iron ions to exist stably in the electrolyte 2a. This suppresses oxidation of divalent iron ions to trivalent iron ions due to dissolved oxygen in the electrolyte 2a, oxygen gas in a gas phase, oxygen gas generated by photocatalytic activity, or the like.

For example, a pH of the electrolyte 2a may be adjusted by adjusting an iron sulfate concentration, an iron perchlorate concentration, or the like of the electrolyte 2a, or a pH of the electrolyte 2a may be adjusted by adding an acidic material such as sulfuric or perchloric acid to the electrolyte 2a.

When an electrolyte is prepared by dissolving about 50 g of iron perchlorate n-hydrate (manufactured by FUJIFILM Wako Pure Chemical Cooperation: n is about 8) in 10 L of water, the electrolyte has a pH of about 2.

The iron ion concentration of the electrolyte 2a is preferably, for example, 10 mmol/L to 1 mol/L. This is a concentration at which the iron ions can stably maintain respective valence states thereof. More preferably, the iron ion concentration of the electrolyte 2a is 10 mmol/L to 100 mmol/L. The lower the iron ion concentration, the smaller an effect coloring of the electrolyte caused by the iron ions, and the more decrease in an amount of light received by the photocatalyst can be suppressed.

The photocatalytic cell 13 can include an inlet 10a provided so as to supply the electrolyte 2a containing the first cation into the photocatalytic cell 13 and an outlet 11a provided so as to discharge the electrolyte 2a containing the second cation from the photocatalytic cell 13. The inlet 10a and the outlet 11a may be provided so that the electrolyte 2a flows through the photocatalytic cell 13. This allows the first cation contained in the electrolyte 2a injected into the photocatalytic cell 13 from the inlet 10a to come into contact with the photocatalyst particle, and the first cation can be reduced by photocatalytic activity and converted into the second cation. Further, the electrolyte 2a containing the second cation generated by photocatalytic activity can be taken out from the photocatalytic cell 13, and the electrolyte 2a containing the second cation can be used.

### Hydrogen Gas Generation System

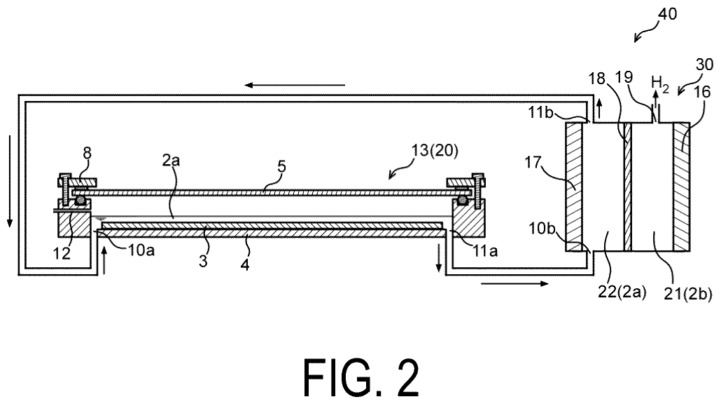

FIG. 2 is a schematic cross-sectional view of a hydrogen gas generation system of the present embodiment.

A hydrogen gas generation system 40 of the present embodiment includes a cation reduction device 20 and an electrolyzer 30 including a cathode 16 and an anode 17. The electrolyzer 30 is configured to generate hydrogen gas from water or hydrogen ions at the cathode 16 and to oxidize a second cation to a first cation at the anode 17. The cation reduction device 20 and the electrolyzer 30 are configured to supply an electrolyte 2a containing the second cation generated by the cation reduction device 20 to the electrolyzer 30, and are configured to supply the electrolyte 2a containing the first cation generated at the anode 17 to the cation reduction device 20.

The electrolyzer 30 may include a power supply unit provided to apply a voltage between the anode 17 and the cathode 16. The electrolyzer 30 may include an anode chamber 22 and a cathode chamber 21 separated by an ion exchange membrane 18.

The electrolyte 2a containing the second cations generated by the cation reduction device 20 is supplied to the electrolyzer 30 to fill the anode chamber 22 with the electrolyte 2a and the cathode chamber 21 with an electrolyte 2b. Then, when a voltage is applied between the anode 17 and the cathode 16 using the power supply unit, anodic reaction proceeds on a surface of the anode 17, and cathodic reaction proceeds on a surface of the cathode 16. With the anodic reaction and the cathodic reaction, hydrogen ions (H⁺) contained in the electrolyte 2a in the anode chamber 22 move to the electrolyte 2b in the cathode chamber 21 through the ion exchange membrane 18. The electrolyte 2b can be an acidic electrolyte.

In the anode 17, a reaction proceeds in which the second cations contained in the electrolyte 2a in the anode chamber 22 transfer electrons to the anode 17 and are oxidized to the first cations (anodic reaction).

For example, when the first cation is a trivalent iron ion (Fe³⁺) and the second cation is a divalent iron ion (Fe²⁺), the following anodic reaction proceeds.

Anodic reaction: Fe²⁺→Fe³⁺+e⁻

The anode chamber 22 may include an inlet 10b provided to supply the electrolyte 2a containing the second cations generated in the cation reduction device 20 into the anode chamber 22 and an outlet 11b provided to discharge the electrolyte 2a containing the first cations generated from the second cations at the anode 17 from the anode chamber 22. The inlet 10b and the outlet 11b may be provided so that the electrolyte 2a injected from the inlet 10b passes through the anode chamber 22 and then is discharged from the outlet 11b. By circulating the electrolyte 2a in this way, the anodic reaction can proceed continuously and stably.

The electrolyte 2a containing the second cations generated in the cation reduction device 20 may be supplied to the anode chamber 22 of the electrolyzer 30 through a liquid feed pipe and a pump. The electrolyte 2a containing the second cations generated in the cation reduction device 20 may be stored in a storage tank. The electrolyte 2a may then be transported in a state of being stored in the storage tank, and the electrolyte 2a stored in the storage tank may be supplied to the anode chamber 22 of the electrolyzer 30 at a destination.

The electrolyte 2a containing the first cations discharged from the anode chamber 22 of the electrolyzer 30 may be supplied to the cation reduction device 20 through a liquid feed pipe and a pump. The electrolyte 2a containing the first cations discharged from the anode chamber 22 of the electrolyzer 30 may be stored in a storage tank. The electrolyte 2a may then be transported in a state of being stored in the storage tank, and the electrolyte 2a stored in the storage tank may be supplied to the cation reduction device 20 at a destination.

In such a system in which the electrolyte 2a is circulated, water may be added to the circulating electrolyte 2a. This allows the water consumed in the second reaction described above to be replenished.

At the cathode 16, the following cathodic reaction proceeds in which hydrogen ions contained in the electrolyte 2b in the cathode chamber 21 receive electrons to generate hydrogen gas.

Cathodic reaction: 2H⁺+2e⁻→H₂

The generated hydrogen gas is discharged to the outside of the cathode chamber 21 through a hydrogen gas discharge hole 19 and stored in a hydrogen storage tank.

The anodic reaction and the cathodic reaction described above proceed at a lower applied voltage (a voltage applied between the cathode 16 and the anode 17 by the power supply unit) than in known water electrolysis systems. Therefore, the cost of producing hydrogen gas can be reduced.

### Zeta Potential Measurement Experiment

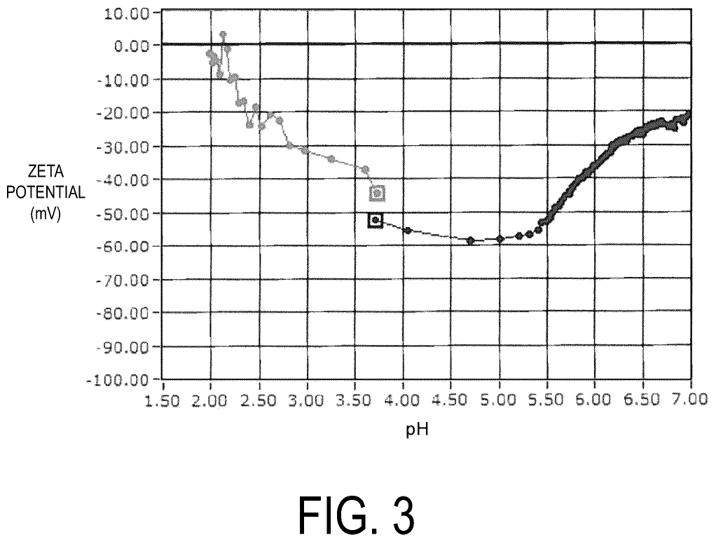

A dispersion (pH: 3.7) was prepared by dispersing 1 wt. % tungsten oxide particles in pure water. The pH of the dispersion was changed by adding 10 μL of 0.1 N HCl or 10 μL of 0.1 N NaOH to the dispersion at 20 second intervals, while the zeta potential of the tungsten oxide particles contained in the dispersion was measured using nanoparticle tracking analysis (NTA). FIG. 3 is a graph showing a relationship between the pH of the dispersion and the measured zeta potential. The results of this experiment show that as the pH of the dispersion decreases from 4, the zeta potential of the tungsten oxide particles gradually increases, and when the pH of the dispersion reaches about 2, the zeta potential of the tungsten oxide particles becomes about 0 mV.

### DESCRIPTION OF SYMBOLS

2a, 2b: Electrolyte
3: Photocatalyst support
4: Container
5: Translucent member
6: Sealing member
7: Cushioning material
8: Cover
9: Bolt
10a, 10b: Inlet
11a, 11b: Outlet
12: Oxygen gas discharge hole
13: Photocatalytic cell
16: Cathode
17: Anode
18: Ion exchange membrane
19: Hydrogen gas discharge hole
20: Cation reduction device
21: Cathode chamber
22: Anode chamber
30: Electrolyzer
40: Hydrogen gas generation system

1. A cation reduction device comprising:
a photocatalytic cell containing an electrolyte containing a first cation and photocatalyst particles,
wherein the electrolyte and the photocatalyst particles reduce a first cation to a second cation by photocatalytic activity of the photocatalyst particles generated by receiving light, and
a pH of the electrolyte is within a pH range in which a zeta potential of the photocatalyst particles is 0 mV or higher.

2. The cation reduction device according to claim 1,
wherein the electrolyte has a pH of less than 2.

3. The cation reduction device according to claim 1,
wherein the first cation is a trivalent iron ion, and
the second cation is a divalent iron ion.

4. The cation reduction device according to claim 3,
wherein the electrolyte contains iron ions in a concentration of 10 mmol/L or more and 1 mol/L or less.

5. The cation reduction device according to claim 1,
wherein the photocatalytic cell includes an inlet that supplies an electrolyte containing a first cation into the photocatalytic cell, and an outlet that discharges an electrolyte containing a second cation from the photocatalytic cell.

6. The cation reduction device according to claim 1,
wherein the photocatalyst particles include tungsten oxide particles.

7. The cation reduction device according to claim 1,
wherein the photocatalyst particles are supported or fixed on a support.

8. A hydrogen gas generation system comprising:
the cation reduction device according to claim 1; and
an electrolyzer including a cathode and an anode,
wherein the electrolyzer generates hydrogen gas from water or hydrogen ions at the cathode, and oxidizes a second cation to a first cation at the anode, and
the cation reduction device and the electrolyzer supply an electrolyte containing the second cation generated by the cation reduction device to the electrolyzer, and supply an electrolyte containing the first cation generated at the anode to the cation reduction device.
